(19) United States
(12) Patent Application Publication
(10) Pub. No.: US 2026/0086030 A1
(43) Pub. Date: Mar. 26, 2026

(54) METHOD AND DEVICE FOR DETERMINING THE REFRACTIVE INDEX OF A WEDGE-SHAPED TEST OBJECT

(71) Applicant: Trioptics GmbH, Wedel (DE)

(72) Inventor: Josef HEINISCH, Wedel (DE)

(73) Assignee: Trioptics GmbH, Wedel (DE)

(21) Appl. No.: 19/112,573

(22) PCT Filed: Sep. 15, 2023
(86) PCT No.: PCT/EP2023/075443

§ 371 Date: Mar. 17, 2025

(30) Foreign Application Priority Data
Sep. 15, 2022 (DE) 10 2022 123 591.2

(51) Int. Cl. G01N 21/41; G01B 11/26; G01M 11/02

(52) U.S. Cl. CPC G01N 21/4133; G01B 11/26; G01M 11/0207; G01M 11/025; G01N 2021/4153

(57) ABSTRACT

The invention relates to a method for determining a refractive index of an optical test object (100), which has a first surface (102) and a second surface (104) arranged at a wedge angle (ω) to the first surface (102), the method comprising the following steps: detecting a first reflection light beam (401), a second reflection light beam (402) and a third reflection light beam (413), wherein the first reflection light beam (401) represents a light beam reflected at the first surface (102) and wherein the second reflection light beam (402) represents a light beam reflected at the second surface (104) and wherein the third reflection light beam (413) represents a light beam reflected at a mirror element (420), determining a first angle (a) between the first reflection light beam (401) and the second reflection light beam (402) and determining a second angle (β) with the aid of the third reflection light beam (413), and calculating (315) the refractive index (n) using the first angle (a) and the second angle (β).

The present approach relates to a method for determining a refractive index of an optical test object, a device, and a measuring system.

Various approaches are known for the refractive index measurements on optical prisms having small prism angles or optical wedges, which can detect a back reflection on an inner side of the prism or the wedge with the aid of an autocollimator. For example, the refractive index of the wedge material can be determined with known angles of incidence and apex with the aid of Snell's law of refraction. The methods described in the prior art share the feature that the apex angle is determined in preparation for the measurement with the aid of a goniometer, by which the measurement effort is increased overall.

### DISCLOSURE OF THE INVENTION

Against this background, the present approach presents a method for determining a refractive index of an optical test object, a device, and a measuring system according to the main claim. Advantageous embodiments result from the respective dependent claims and the following description.

The advantages achievable with the presented approach are that the refractive index of a wedge-shaped test object can be measured without the wedge angle or the apex angle being known, by which a simple measurement with little time expenditure can be enabled, or the measuring process can be greatly simplified.

A method for determining a refractive index of an optical test object is presented, wherein the test object comprises at least one first surface and one second surface arranged at a wedge angle in relation to the first surface. The method comprises a step of detecting a first reflection light beam, a second reflection light beam, and a third reflection light beam. The first reflection light beam represents a light beam reflected on an outer side of the first surface here and the second reflection light beam represents a light beam reflected on an inner side of the second surface and the third reflection light beam represents a light beam reflected on a mirror surface of a mirror element. The mirror element is interpreted here as arranged on a side of the test object opposite to a light source emitting the light beam. Furthermore, the method comprises a step of determining a first angle with the aid of the first reflection light beam and/or the second reflection light beam and determining a second angle with the aid of the third reflection light beam. Moreover, the method comprises a step of calculating the refractive index using the first angle and the second angle.

Using the method presented here, for example, a refractive index measurement can be carried out on an at least partially wedge-shaped lens or another, for example, prism-shaped optical element. The test object can accordingly also be referred to hereinafter as a wedge or as a prism. In a method step, reflections of a light beam emitted by a light source are detected. A first angle α is determined using these detected reflection light beams. This angle is enclosed by two light beams reflected on different test object surfaces. Depending on the orientation of the test object, the angle α can be determined in one embodiment only with the aid of the light beam reflected on the first test object surface. In such an embodiment, the orientation of the test object is to be monitored with the aid of an additional sensor. The first reflection can occur here, for example, on the test object surface which is struck first by the incident light beams. The second reflection can occur here on an inner side of the test object which is opposite to the first test object surface and encloses the wedge angle of the test object therewith. Moreover, a second angle β is determined. This is enclosed between the incident light beams, and light beams which are reflected on a mirror, which can be located below the test object, for example, and propagate a second time through the test object. The location of the incident light beams is to be determined in preparation for the measurement, without test object in the beam path, by reflection on the mirror. The mirror is to be positioned approximately orthogonally to the incident light beams here. If the test object is rotatably mounted, however, which represents the preferred measuring configuration, the mentioned reference measurement without test object can be omitted. The angle β is then determinable directly from the diameter of the wobble circle on the camera.

Finally, in the step of calculation, the refractive index n of the test object material is calculated. For example, this can be determined from the two angles with the aid of the following relationship:

$$n = {n}_{Air} \frac{α}{α - β}$$

n_{Air} designates the refractive index of the surrounding medium.

According to one embodiment, the method can comprise a step of emitting a bundle of collimated light beams from the light source in the direction of the first surface. For example, the light beams can be output by a light source formed as an LED, for example, and collimated using a collimator, for example. In this case, for example, during the emission of the light beams, the light source or the collimator can be arranged sequentially with the test object, or with a mount holding the test object, and the mirror element. The test object can thus advantageously be optimally illuminated and reflection light beams having maximum intensity can be generated.

Moreover, in the step of emitting, the light beam can be emitted at an angle between 8° and 100°, in particular a right angle, with respect to the first surface of the test object. For example, the light beam or a plurality of collimated light beams can be directed orthogonally onto the outer side of the first surface. This offers the advantage that both the first angle and the second angle can be determined with high precision. Such an alignment only represents a special case for the purpose of illustration. The method also functions if the outer side of the first surface is not aligned orthogonally to the incident light beams.

Furthermore, an embodiment of the approach presented here is advantageous in which the test object is initially oriented so that first and second surface are exchanged with respect to their orientation. The first angle α can now be measured without passage through the test object material with the aid of the first reflection light beam. No change results for the second angle β. The refractive index n can now be determined, for example, with the aid of the following formula:

$$n = {n}_{Air} \frac{β + α}{α}$$

This slightly modified formula has the advantage that the measurement errors for high refractive indices can be reduced, as will be explained later.

For the functioning of this variant, it is helpful to know how strongly the side resting on the test object table is tilted in relation to the optical axis of the incident light beam. For this purpose, the measuring device is expanded by a sensor, which, with the aid of a light beam reflected on the test object lower side, determines its tilt, so that it can be calculated out in the context of the measurement.

According to a further embodiment, the method can comprise a step of aligning the mirror surface of the mirror element orthogonally to the incident light beam. For example, the mirror element can be formed having a planar reflective mirror surface. In the step of aligning, the mirror surface can be aligned approximately or sufficiently orthogonally to the incident light beam for this purpose, wherein it can be aligned, for example, parallel with the first surface of the test object. A preceding calibration (determination of the zero position) of the mirror without test object is necessary if the measurement of the refractive index takes place without test object rotation.

According to a further embodiment, in the step of detecting, the first reflection light beam, the second reflection light beam, and the third reflection light beam can be detected simultaneously. For example, collimated light beams can be emitted in the direction of the test object or the mirror element arranged behind the test object starting from the light source and the reflections of these light beams can be detected simultaneously. This offers the advantage that the method presented here can be carried out in a time-saving manner.

According to a further embodiment, the steps of detecting, determining, and calculating can be carried out repeatedly, wherein in the repeated step of detecting, the reflection light beams are interpreted as reflections of different wavelengths. For example, the measurement of the refractive index can be carried out sequentially at multiple different wavelengths. The light source can be implemented as polychromatic, for example, as a white light LED, for this purpose. To set one or more measuring wavelengths, for example, an autocollimator or the light source unit can have exchangeable optical filters. The objective of the autocollimator can be designed so that it can be moved linearly in order to thus compensate for longitudinal chromatic aberrations. The refractive index can thus advantageously be determined particularly precisely.

According to a further embodiment, the method can comprise a step of actuating a rotation of the test object around an axis of rotation arranged parallel to the light beam. The step of rotating can be carried out here simultaneously with the step of detecting. Additionally or alternatively, the step of rotating can also be carried out simultaneously with a step of emitting light by a light source. For example, the test object can be rotated by means of a corresponding mount around an axis which can extend parallel to the incident collimated light beams. This offers the advantage that the second angle, without alignment of the mirror element, can be determined directly from the diameter of a wobble circle arising due to the rotation.

This method can be implemented, for example, in software or hardware or in a mixed form of software and hardware, for example, in a control unit.

The approach presented here furthermore provides a device which is designed to carry out, actuate, or implement the steps of a variant of a method presented here in corresponding apparatuses. The object underlying the invention can be achieved rapidly and efficiently by means of this device.

For this purpose, the device can comprise at least one computing unit for processing signals or data, at least one memory unit for storing signals or data, at least one interface to a sensor or an actuator for inputting sensor signals from the sensor or for outputting data or control signals to the actuator, and/or at least one communication interface for inputting or outputting data which are embedded in a communication protocol. The computing unit can be, for example, a signal processor, a microcontroller, or the like, wherein the memory unit can be a flash memory or a magnetic memory unit. The communication interface can be designed to input or output data in a wireless and/or wired manner, wherein a communication interface which can input or output data in a wired manner can output these data, for example, electrically or optically from a corresponding data transmission line or input these data into a corresponding data transmission line.

A device can be understood in the present case as an electrical device which processes sensor signals and outputs control and/or data signals as a function thereof. The device can comprise an interface which can be designed in hardware and/or software. In the case of a hardware design, the interfaces can be, for example, part of a so-called system ASIC, which contains greatly varying functions of the device. However, it is also possible that the interfaces are separate integrated circuits or at least partially consist of discrete components. In the case of a software design, the interfaces can be software modules which are present, for example, on a microcontroller in addition to other software modules.

Moreover, a measuring system for measuring a refractive index of an optical test object is presented, wherein the measuring system comprises a variant of the device presented above. The device is designed here to actuate a light source and additionally or alternatively a receptacle element and additionally or alternatively a mirror element of the measuring system. Furthermore, the measuring system comprises the light source for emitting a light beam, the receptacle element for receiving the test object, and the mirror element, wherein the mirror element is arranged on a side of the receptacle element opposite to the light source. The measuring system presented here offers the advantage that a method as described above can be implemented optimally.

According to one embodiment, the measuring system can have a collimator comprising the light source, wherein the collimator can comprise a plurality of exchangeable optical filters for filtering the light beam. For example, the measuring system can comprise an autocollimator for illuminating the test object and for detecting the reflections arising on the respective test object surfaces. The light source and a reticle can be arranged in the illumination arm of the autocollimator, for example. In this case, the light source can be polychromatic, for example, and can be implemented, for example, as a white light LED. The autocollimator or the light source unit can have exchangeable optical filters in order to advantageously be able to set one or more measuring wavelengths. Additionally or alternatively, the objective of the autocollimator can be designed so that it can be moved linearly in order to thus compensate for longitudinal chromatic aberrations.

According to a further embodiment, the mirror element can have a settable aperture diaphragm. The mirror can have, for example, an additional settable aperture diaphragm for beam limiting. This offers the advantage that by changing the intensity of the reflected light beams, the contrast of the detected reflections can be matched to one another. Furthermore, the reflectivity of the mirror surface can advantageously be in a comparable order of magnitude as the reflectivity of the test object surface, so that the reflections on the individual surfaces can be detected without adaptation of the integration times of a camera.

According to a further embodiment, the receptacle element can be rotatably mounted. For example, the receptacle element can optionally be rotatably mounted around an axis of rotation extending in parallel to the optical axis of the autocollimator, due to which a tilt between the axis of rotation of the test object mount and the mirror surface or a tilt of the mirror in relation to the optical axis of the autocollimator can advantageously be compensated for by computer. The test object can alternatively also be placed on a test object table. In this embodiment, the autocollimator would advantageously be located below the test object and the mirror above the test object and the wedge would be placed best having one of the long sides on the test object table.

According to a further exemplary embodiment, the light source and the mirror element can be rotatable around a common axis. For example, alternatively to the rotation of the test object mount, the autocollimator can also be rotated together with the mirror around a corresponding common axis. The test object together with the receptacle can remain fixed in place here. A tilt between the axis of rotation of the test object mount and the mirror surface or a tilt of the mirror in relation to the optical axis of the autocollimator can also advantageously be compensated for by computer by way of this variant. Without rotation of the receptacle element, in a preparatory step, the mirror surface is to be aligned toward the autocollimator or a residual error with respect to the tilt of the mirror surface in relation to the optical axis of the autocollimator is to be determined. This preparatory step is carried out without the test object.

According to a further embodiment, the receptacle element can be designed to receive a liquid and additionally or alternatively a solid. For example, the measuring system can advantageously also be used to measure the refractive index of a liquid. For this purpose, the liquid to be measured is to be stabilized in a suitable manner. The liquid can be clamped, for example, between two plane-parallel plates such that this liquid adopts the shape of a wedge. The measurement can therefore advantageously be carried out analogously to the measurement of a solid. In this constellation, the test object is to remain fixed in place and the autocollimator together with mirror is to be rotated. Furthermore, very good flatness of the plane-parallel plates is to be ensured.

A computer program product or computer program having program code, which can be stored on a machine-readable carrier or memory medium such as a semiconductor memory, a hard drive memory, or an optical memory and is used to carry out, implement, and/or actuate the steps of the method according to one of the above-described embodiments, in particular when the program product or program is executed on a computer or a device, is also advantageous.

Exemplary embodiments of the approach presented here are shown in the drawings and explained in more detail in the following description. In the figures:

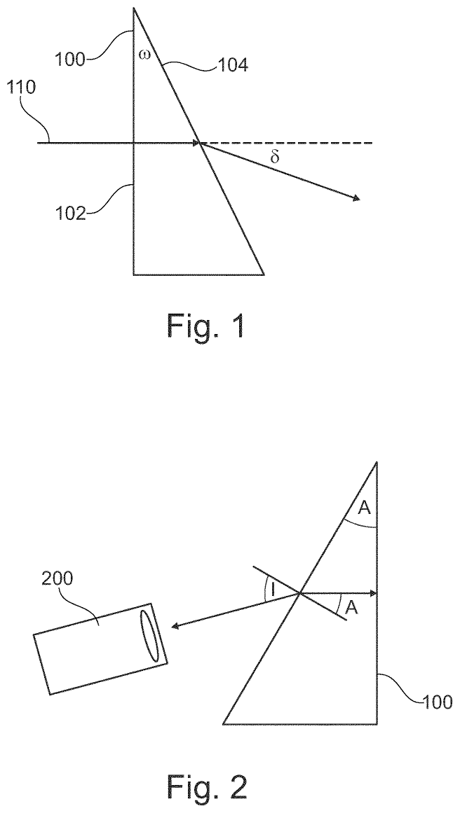

FIG. 1 shows a schematic representation of an optical test object according to an exemplary embodiment;

FIG. 2 shows a schematic representation of an optical test object and a measuring method;

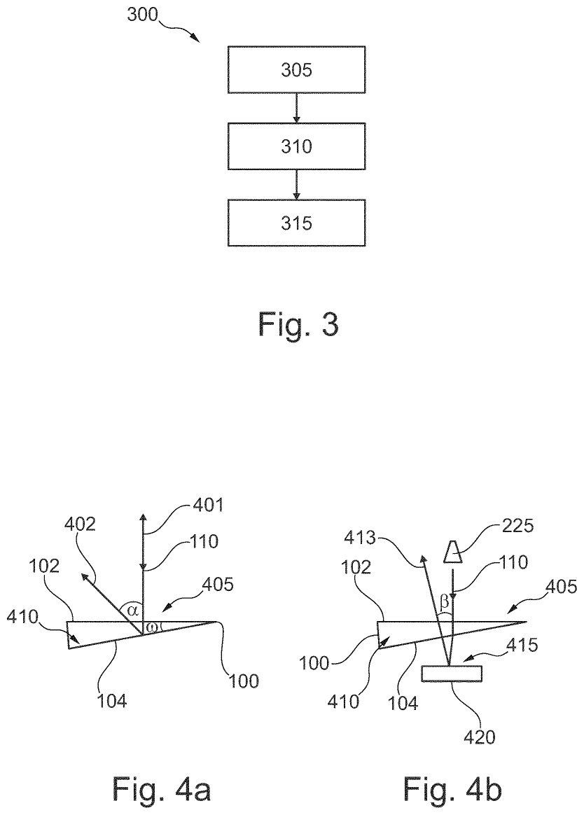

FIG. 3 shows a flow chart of a method for determining a refractive index of an optical test object according to an exemplary embodiment;

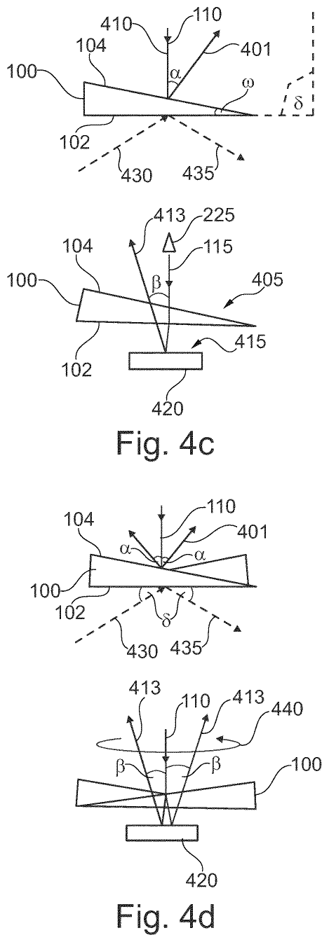

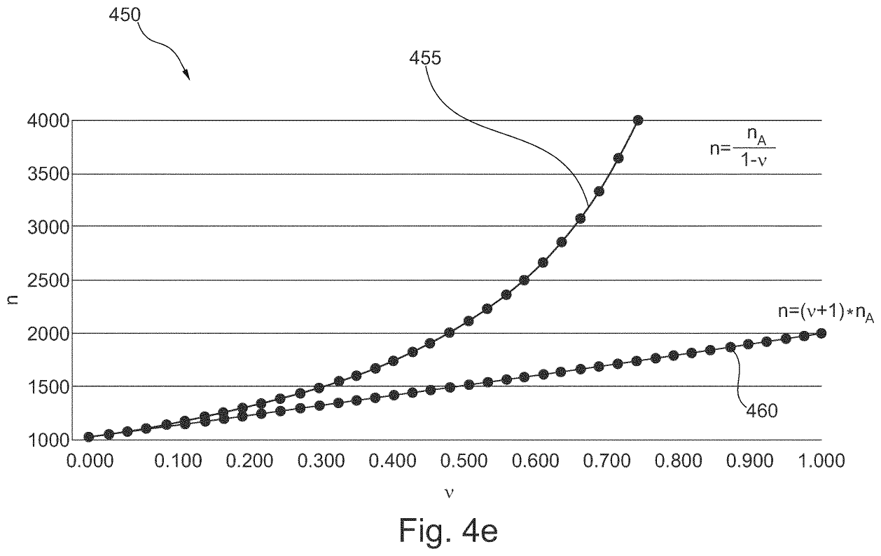

FIG. 4a shows a schematic representation of an exemplary embodiment of an optical test object;

FIG. 4b shows a schematic representation of an exemplary embodiment of an optical test object;

FIG. 4c shows a schematic representation of an exemplary embodiment of the measurement of a refractive index of an optical test object;

FIG. 4d shows a schematic representation of an exemplary embodiment of the measurement of a refractive index of an optical test object

FIG. 4e shows a diagram to illustrate the change of the refractive index in relation to a ratio of the two angles α and β;

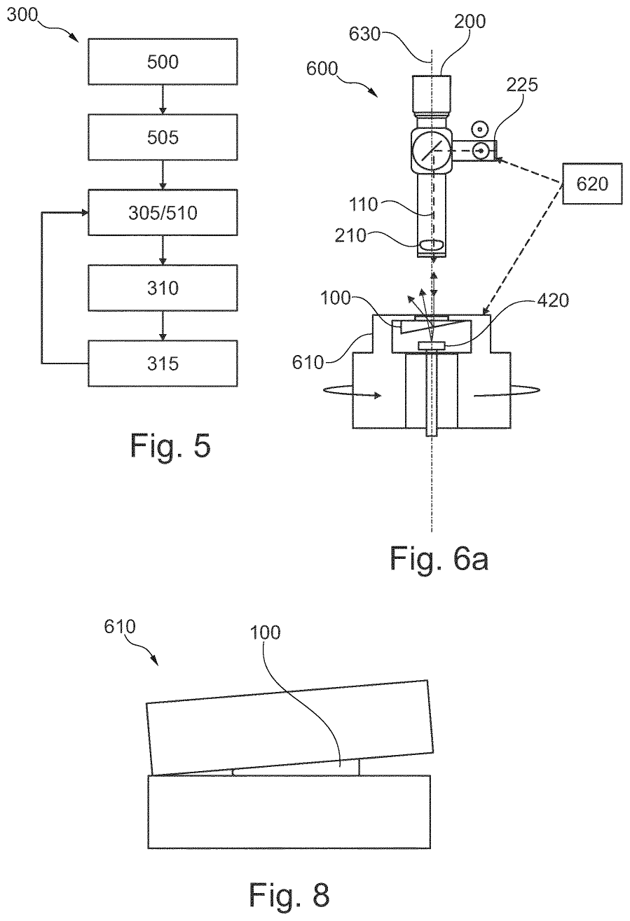

FIG. 5 shows a flow chart of a method for determining a refractive index of an optical test object according to an exemplary embodiment;

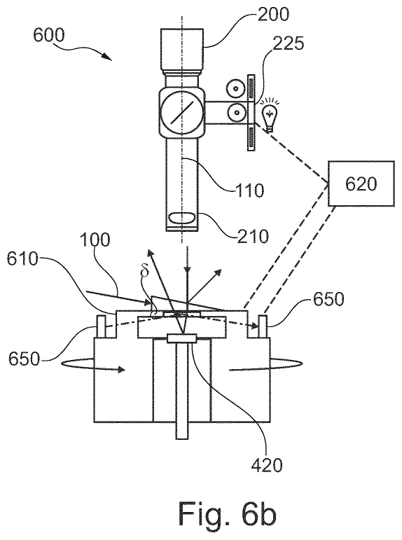

FIG. 6a shows a schematic representation of an exemplary embodiment of a measuring system for measuring a refractive index of an optical test object;

FIG. 6b shows a schematic representation of an exemplary embodiment of a measuring system for measuring a refractive index of an optical test object;

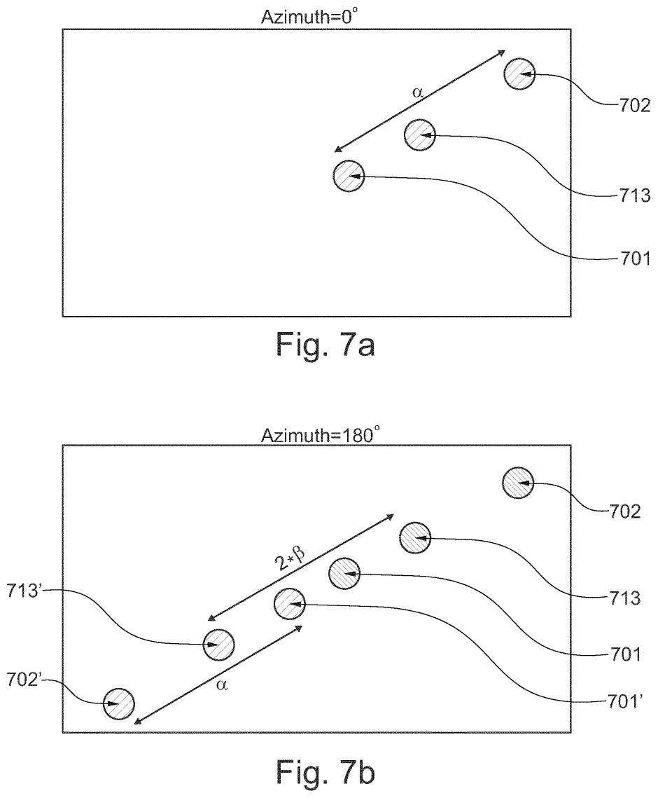

FIG. 7a shows an exemplary camera image of detected reflections with a test object rotation (azimuth) of 0°;

FIG. 7b shows an exemplary camera image of detected reflections with a test object rotation (azimuth) of 180°; and

FIG. 8 shows a schematic cross-sectional representation of an exemplary embodiment of a receptacle element for receiving a liquid test object.

In the following description of favorable exemplary embodiments of the present invention, identical or similar reference signs are used for the elements illustrated in the various figures and acting similarly, wherein a repeated description of these elements is omitted.

FIG. 1 shows a schematic representation of an optical test object 100 according to an exemplary embodiment. The test object 100 shown here is formed solely by way of example as a wedge-shaped prism and comprises a first surface 102 and a second surface 104 arranged at a wedge angle ω in relation to the first surface 102. The wedge angle ω can generally also be designated as an apex angle A. Upon illumination of the test object 100 using a light beam 110 from the side of the first surface 102, the light is deflectable in the general course through the prism or the wedge. The deflection δ of the light beam 110 depends here on the refractive index n and the wedge angle ω. The deflection δ is representable here by the following formula:

$$δ = ( n - {n}_{Air} ) ω$$

FIG. 2 shows a schematic representation of an optical test object 100 according to an exemplary embodiment. The test object 100 shown here corresponds or is similar to the test object described in the preceding figure. The measuring method shown in this figure corresponds to the prior art, wherein a back reflection on an inner side of the prism/wedge is detectable by means of an autocollimator 200. In this method, the refractive index of the wedge material is determinable with the aid of Snell's law of refraction with known angle of incidence i and apex angle A.

The measuring method illustrated here according to the prior art has the disadvantage that the apex angle A or the wedge angle ω is determined in preparation for the measurement of the refractive index with the aid of a goniometer, by which the measurement effort is increased overall.

FIG. 3 shows a flow chart of a method 300 for determining a refractive index of an optical test object according to an exemplary embodiment. The method shown here is applied in the case of a test object as was described in the preceding figures, assumed to have at least one first surface and a second surface arranged at a wedge angle in relation to the first surface.

The method 300 comprises a step 305 of detecting a first reflection light beam, a second reflection light beam, and a third reflection light beam. The first reflection light beam represents here a light beam reflected on an outer side of the first surface and the second reflection light beam represents a light beam reflected on an inner side of the second surface and the third reflection light beam represents a light beam reflected on a mirror surface of a mirror element. The mirror element is interpreted here as arranged on a side of the test object opposite to a light source emitting the light beam.

The method 300 moreover comprises a step 310 of determining a first angle between the first reflection light beam and the second reflection light beam and determining a second angle with the aid of the third reflection light beam.

Moreover, the method 300 comprises a step 315 of calculating the refractive index using the first angle and the second angle.

The method 300 described here is based on the finding that the refractive index of a wedge-shaped test object can be measured without the wedge angle or the apex angle having to be known, due to which a multistep measurement is not required or the measuring process is significantly simplified.

FIGS. 4a and 4b each show a schematic representation of an exemplary embodiment of an optical test object 100, on which a method for determining a refractive index, as was described in preceding FIG. 3, can be carried out. In FIG. 4a, a determination of a first angle α is illustrated and in FIG. 4b, a determination of a second angle β is illustrated.

In one exemplary embodiment, during the measurement the test object 100 is illuminated using collimated light, solely by way of example, which is depicted in the illustration shown here by means of a light beam 110. In one advantageous embodiment, the first surface 102 of the test object 100, i.e. a test object surface, is oriented solely by way of example orthogonally to the incident light beams.

In a first measuring step shown in FIG. 4a, a first angle α is determinable. This angle is arranged between a first reflection light beam 401 and a second reflection light beam 402, wherein the first reflection light beam 401 represents the light beam 110 reflected on an outer side 405 of the first surface 102 and the second reflection light beam 402 represents the light beam 110 reflected on an inner side 410 of the second surface 104. In other words, the first angle α is enclosed by two light beams reflected on different test object surfaces 102, 104. The first reflection arises here on the test object surface which is struck first by the incident light beams. The second reflection arises here on an inner side of the test object 100, which is opposite to the first test object surface and encloses the wedge angle ω therewith.

In one exemplary embodiment, the first angle α can be calculated using the following formula:

$$α * {n}_{Air} = 2 n ω$$

In a second measuring step shown in FIG. 4b, a second angle β is determinable. This is arranged between the incident light beam 110 and a third reflection light beam 413, wherein the third reflection light beam 413 represents a light beam reflected on a mirror surface 415 of a mirror element 420. In the depiction shown here, the mirror element 420, which can also be referred to simply as a mirror, is arranged on the side of the second surface 104 of the test object 100 such that the mirror surface 415 is aligned parallel to the first surface 102 and opposite to a light source 225 outputting the light beam 110. Furthermore, the incident light beam 110 extends orthogonally to the mirror surface 415. Accordingly, the second angle β is an angle which is enclosed between the light beams which are reflected on a mirror, which is located in the depiction shown here below the test object 100, and propagate a second time through the test object, and light beams which are reflected on the mirror mentioned without the test object being located in the beam path. However, the method functions even if the first test object surface 405 and the mirror surface 415 are not aligned parallel to one another and are also not aligned orthogonally to the incident light beam 110. In other words, the angle β is enclosed between the light beam 413 and a reference reflection light beam, which arises on the mirror surface 415, without the test object being located in the beam path. The reference reflection light beam is not shown here for reasons of clarity, since it coincides with the incident light beam 110 for the case that the mirror is aligned orthogonally to the incident light beam 110. In the preferred application, in which the test object is rotated, a reference measurement without test object is not required. Upon the rotation of the test object, the reflection light beam 413 generates a wobble circle on the detection surface. The angle β can be calculated directly from the diameter of this wobble circle. This relationship will be explained in more detail later in conjunction with FIG. 7. In summary, it can be stated at this point that the angle β can be determined with the aid of the reflection light beam 413.

Alternatively, the test object can also be illuminated from the lower side. In this case, the mirror is located above the test object.

The second angle β is calculable using the following formula by way of example:

$$β * {n}_{Air} = 2 ( n - {n}_{Air} ) ω$$

Furthermore, the measurement is designed in one exemplary embodiment so that all reflections are detectable at the same time, so that both angles α, β are measurable simultaneously.

The refractive index of the test object material is now determinable with the aid of the following relationship from the two angles α, β:

$$n = {n}_{Air} \frac{α}{α - β}$$

In this context, it is to be noted that no measurement of the absolute angles is necessary. A calibration factor of the angle measuring system drops out in the measurement, since there is an angle in the numerator and denominator of the formula.

The test object 100 is designed here solely by way of example so that the wedge angle ω has a value <1° or <0.5°.

A further advantage of the measuring method described here is that no calibration of the measuring system is necessary, since only the ratio of the two angles α and β is decisive for the measurement of the refractive index.

FIG. 4c shows a schematic representation of an exemplary embodiment for measuring a refractive index of an optical test object 100 on which a method for determining a refractive index, as was described in preceding FIG. 3, is performable. In contrast to the illustration in FIGS. 4a and 4b, the test object is oriented so that the side 104 faces upward, so that now the incident light beam 110 is reflected on side 104 at the angle α. The angle α can now be determined with the aid of the first reflection light beam 401 via the following relationship:

$$α = 2 ω$$

The above-described relationship applies for the angle β. For the functioning of this exemplary embodiment, it is necessary for the test object surface 102 to be oriented as perpendicularly as possible to a reference axis, for example, the optical axis of the incident light beam 110. If a tilt angle δ is present between the side 102 and a reference axis, for example, the optical axis of the incident light beam 110, it is to be determined. This tilt angle can then be calculated out in the context of the measurement.

This tilt angle δ can be determined, for example, by a sensor (not shown in FIG. 4c), which emits a sensor light beam 430 onto the side 102 of the test object 100 and detects a corresponding sensor reflection light beam 435 on an opposite side and determines its direction. The tilt angle δ and/or the position of the test object 100 in relation to this sensor can then be determined or detected from the knowledge of the directions of the sensor light beam 430 and the sensor reflection light beam 435. With an alignment of the side 102 of the test object 100 in relation to the optical axis of the incident light beam 110 at an angle of 90°, it can be assumed that for the first angle, α=2·ω applies. For the second angle β, which represents or maps the angle of the light transmitted through the test object 100, a relationship of β=2·(n−n_{A})·ω/n_{A} applies. If both equations are solved for n, the following relationship results:

$$n = {n}_{Air} \frac{β + α}{α}$$

FIG. 4d shows a schematic representation of an exemplary embodiment for measuring a refractive index of an optical test object 100 on which a method for determining a refractive index, as was described in preceding FIG. 3, is performable. In contrast to the procedure according to the illustration from FIG. 4c, a rotation 440 of the test object 100 is now also taken into consideration. In this way, the relationship for the first angle α and the second angle β is α=4·ω and β=4. (n−n_{A})·w/n_{A}. The rotation of the test object, independently of how it is oriented, causes a factor 2 to be incorporated into the formulas for the angles α and β. The rotation has no influence on the calculation of the refractive index. However, it is metrologically advantageous since the amount of data is thus increased, in particular if a full wobble circle is measured. Adjustment errors of the measuring system, which result in measuring errors in the angles, can also thus be recognized and corrected more easily by a shift of the wobble circle.

FIG. 4e shows diagram 450 to represent the change of the refractive index in relation to a ratio v of the two angles α and β, in order to explain the background of the measuring configurations. In this diagram 450, the ratio v of the two angles α and β with v=β/α is plotted on the abscissa and the refractive index n of the test object 100 at a refractive index of the air η_{Air} is plotted on the ordinate. A first graph 455 denotes a determination of the refractive index η of the test object 100 upon use of the embodiment of FIG. 4a and FIG. 4b and a second graph 460 denotes the determined refractive index n of the test object 100 using the exemplary embodiment according to FIG. 4c or FIG. 4d. The measurement errors for the refractive index correlate with the slope of the respective curve. The presented procedure according to FIGS. 4c and 4d can help especially with high refractive indices to reduce the effect of measurement errors or to keep them small.

FIG. 5 shows a flow chart of a method 300 for determining a refractive index of an optical test object according to an exemplary embodiment. The method 300 shown here corresponds or is similar to the method shown in preceding FIG. 3, with the difference that the method 300 comprises additional and/or optional steps in the exemplary embodiment described here.

In this exemplary embodiment, step 305 of detecting is preceded by a step 500 of emitting. In this step 500 of emitting, a bundle of collimated light beams is emitted by a light source in the direction of the first surface of the test object.

In this exemplary embodiment, in step 500 of emitting, the light beam is emitted at a right angle with respect to the first surface of the test object. In another exemplary embodiment, the light beam can also be emitted at an angle between 8° and 100° with respect to the first surface of the test object.

Moreover, the method 300 in this exemplary embodiment comprises an optional step 505 of aligning the mirror surface of the mirror element orthogonally to the light beam. The alignment of the mirror surface is always required if a rotation of the wedge-shaped test object or the autocollimator is not technically possible. The step of aligning is carried out without a test object in the beam path.

Solely by way of example, step 305 of detecting only takes place following step 500 of emitting in this exemplary embodiment. Simultaneously with the step of detecting, furthermore a step 510 of actuating is performed in this exemplary embodiment. In step 510 of actuating, only a rotation of the test object around an axis of rotation arranged parallel to the light beam is actuated by way of example, so that the reflection light beams are detected in various rotational positions of the test object.

Solely by way of example, in step 305 of detecting, the first reflection light beam, the second reflection light beam, and the third reflection light beam are detected simultaneously.

Moreover, in one exemplary embodiment, steps 305 of detecting, 310 of determining, and 315 of calculating are performed repeatedly, wherein in repeated step 305 of detecting, the reflection light beams are interpreted as reflections of different wavelengths.

In other words, method 300 for measuring the refractive index of a wedge-shaped test object described in this figure and in preceding FIG. 3 can be described as follows:

First, collimated light beams are emitted in the direction of a first surface of the test object and in an optional preparatory step the mirror surface of the mirror element is aligned orthogonally to the incident collimated light beams without the test object being located in the beam path. The incident collimated light beams strike the first surface of the test object solely by way of example at an angle of approximately 90° here. In one exemplary embodiment, the test object is rotated around an axis which extends parallel to the incident collimated light beams. In this case, the step of aligning the mirror surface is omitted.

First light beams reflected on the first surface of the test object are then detected. Moreover, second light beams reflected on the inner side of a second surface of the test object are detected, wherein the second surface encloses a wedge angle with the first surface. A first angle α is determined between the first and second reflected light beams.

Furthermore, third light beams reflected on a mirror arranged sequentially in the beam direction behind the second surface of the test object are detected after they have propagated through the test object again after the reflection on the mirror surface. With the aid of the third reflected light beams, a second angle β is determined. The first, second, and third reflected light beams are detected simultaneously in one exemplary embodiment.

The refractive index of the wedge-shaped test object is then calculated from the first and second angles. In one exemplary embodiment, the measurement of the refractive index is performed sequentially at multiple different wavelengths.

FIG. 6a shows a schematic representation of an exemplary embodiment of a measuring system 600 for measuring a refractive index of an optical test object 100. The measuring system 600 comprises a light source 225 for emitting a light beam 110, a receptacle element 610 for receiving the test object 100, a mirror element 420, and a device 620 which is designed to control a method for determining a refractive index of the optical test object 100 as was described in preceding FIGS. 3 and 5.

In one exemplary embodiment, the light source 225 is formed as part of an autocollimator 200, in order to collimate the light emitted by the light source 225 and conduct it to the test object 100. In this case, the autocollimator comprises the light source 225, which is polychromatic solely by way of example, and optionally a plurality of exchangeable optical filters in the beam path, in order to filter the light emitted by the light source 225.

The mirror element 420 is arranged on a side of the receptacle element 610 opposite to the light source 225. In other words, the autocollimator, the test object mount, and the mirror are arranged sequentially one after another. The receptacle element 610 is designed in this exemplary embodiment as a mechanical mount for the wedge-shaped test object 100 and is rotatably mounted solely by way of example. In a similar manner, the autocollimator 200 having the light source 225 and the mirror element 420 are also rotatable around a common axis 630 in one exemplary embodiment.

Solely by way of example, the mirror element 420 is introduced into the beam path with the aid of a kinematic device and optionally comprises a settable aperture diaphragm. The surface of the mirror and the surfaces of the test object can moreover be designed to have a similar degree of reflection. However, it is important to ensure that reflections which arise on the test object surfaces and reflections which arise on the mirror surface are distinguishable from one another in order to be able to assign the detected signals to the corresponding light beams. For this purpose, it is helpful to know the reflection coefficients of the test object for the desired wavelengths. With the aid of the settable aperture diaphragm, the degree of intensity of the light beams reflected from the mirror surface can be adapted, which is helpful for distinguishing the light beams detected by the detector.

The device 620 is designed in one exemplary embodiment in order, solely by way of example, in addition to outputting light by means of the light source, to also actuate an exemplary movement of an objective of the autocollimator parallel to its optical axis. Additionally or alternatively, a rotation of the receptacle element 610 or a rotation of the autocollimator 200 and the mirror element 420 can be actuated.

FIG. 6b shows a schematic representation of an exemplary embodiment of a measuring system 600 for measuring a refractive index of an optical test object 100. In contrast to the exemplary embodiment of the measuring system 600 shown in FIG. 6a, in the measuring system 600 shown in FIG. 6b, a detection sensor 650 for the tilt angle δ is also provided, the result of which is also taken into consideration or processed in the device 620, as described above. The measuring system 600 according to the illustration from FIG. 6b is therefore only expanded by the following features such that the first angle α is determined with the aid of the first light beam reflected on the inclined edge of the test object and the measuring device is expanded by an additional sensor 650 (which is called a tilt sensor here), which is used for detecting a tilt of the side 102 with respect to the reference axis of the light beam 110 (optical axis).

In other words, the measuring system 600 presented here and the method performable thereby can be described as follows:
The measuring system 600 comprises an autocollimator for illuminating the test object 100 and for detecting the reflections arising on the respective test object surfaces. A reticle, which can be designed, for example, as a pinhole or cross, is located in the illumination arm of the autocollimator. The detection arm comprises, for example, a CMOS or CCD camera. The light source 225 is, for example, polychromatic and is implemented, for example, as a white light LED. The autocollimator or the light source unit can have exchangeable optical filters for setting one or more measuring wavelengths. The objective 210 of the autocollimator can be designed so that it can be moved linearly in order to thus compensate for longitudinal chromatic aberrations.

The test object 100 is fastened in a suitable mount. This can optionally be mounted rotatably around an axis of rotation extending parallel to the optical axis of the autocollimator, by which a tilt between the axis of rotation of the test object mount and the mirror surface or a tilt of the mirror in relation to the optical axis of the autocollimator can be compensated for by computer. Alternatively to the rotation of the test object mount, the autocollimator can also be rotated together with the mirror around a corresponding common axis 630. Without rotation of the test object mount, in a preparatory step, the mirror surface is to be aligned toward the autocollimator or a residual error with respect to the tilt of the mirror surface in relation to the optical axis of the autocollimator is to be determined. This preparatory step is performed without the test object 100.

The test object 100 can alternatively also be placed on a test object table. In this embodiment, the autocollimator would advantageously be located below the test object and the mirror would be located above the test object and the wedge would be laid best with one of the long sides on the test object table.

The mirror can furthermore be pivotable into the beam path or out of the beam path via a kinematic mount.

Furthermore, the reflectivity of the mirror surface is advantageously to be in a comparable order of magnitude as the reflectivity of the test object surface so that the reflections on the individual surfaces can be detected without adapting the integration times of the camera. The mirror can optionally have an additional settable aperture diaphragm for beam limiting. By changing the intensity of the reflected light beams, the contrast of the detected reflections can thus be adapted to one another.

FIG. 7a shows by way of example a first camera image of the three reflection light beams 401, 402, 413. The corresponding detection signals are identified by the reference signs 701, 702, 713. In this example, the angle α is determinable from the distance of the signals 701 and 702. In this case, the mirror would have to be aligned orthogonally to the optical axis of the autocollimator to determine the angle β. The angle β can then be determined from the distance of the signal 713 to a reference signal (not shown), which is detected without test object in the beam path.

FIG. 7b shows by way of example a second camera image of the reflection light beams. In this case, the test object was rotated by an angle (azimuth) of 180°. In addition to the signals 701, 702, 713, additional signals 701′, 702′, and 713′ are detected, which lie on a circular path of a respective wobble circle. As shown in the figure, with the aid of the connection of the signals 713 and 713′, which represents the diameter of a wobble circle, the angle β can be determined. A tilt of the mirror merely ensures that the wobble circle having the diameter 713-713′ is shifted linearly on the detector without the diameter and therefore the angle β changing.

FIG. 8 shows a schematic cross-sectional view of an exemplary embodiment of a receptacle element 610 for receiving a liquid test object 100. The receptacle element 610 shown here corresponds or is similar to the receptacle element described in preceding FIG. 6. The receptacle element 610 is designed in this exemplary embodiment to receive a test object 100, which is a liquid solely by way of example.

The measuring system described in preceding FIG. 6 or the method described in preceding FIGS. 3 and 5 can also be used to measure the refractive index of a liquid. For this purpose, the liquid to be measured is to be stabilized in a suitable manner as illustrated in the figure shown here. The liquid is clamped here between two plane-parallel plates of the receptacle element 610 by way of example, so that it assumes the shape of a wedge. The measurement can therefore be performed analogously to the measurement of a solid. In this constellation, the test object 100 is to remain fixed in place and the autocollimator is to be rotated together with the mirror. Furthermore, very good flatness of the plane-parallel plates is to be ensured.

If an exemplary embodiment comprises an “and/or” link between a first feature and a second feature, this is to be read to mean that the exemplary embodiment comprises both the first feature and the second feature according to one embodiment and comprises either only the first feature or only the second feature according to a further embodiment.

1. A method for determining a refractive index of an optical test object, wherein the test object is assumed to comprise at least one first surface and a second sur-face arranged at a wedge angle in relation to the first surface, the method comprises the following steps comprising:
detecting a first reflection light beam, a second reflection light beam, and a third reflection light beam, wherein the first reflection light beam represents a light beam reflected on an outer side of the first surface and wherein the second reflection light beam represents a light beam reflected on an inner side of the sec-ond surface, and wherein the third reflection light beam represents a light beam reflected on a mirror surface of a mirror element, wherein the mirror element is interpreted as being arranged on a side of the test object opposite to a light source emitting the light beam;
determining a first angle with the aid of the first reflection light beam and/or the second reflection light beam and determining a second angle with the aid of the third reflection light beam;
calculating the refractive index using the first angle and the second angle; and
actuating a rotation of the test object around a rotation axis arranged parallel to the light beam, wherein the step of rotating is performed simultaneously with the step of detecting.

2. The method as claimed in claim 1, having a step of emitting a bundle of collimated light beams from the light source in the direction of the first surface, in particular wherein in the step of emitting, the light beam is emitted at an angle be-tween 80 and 100°, in particular at a right angle, with respect to the first surface of the test object.

3. The method as claimed in claim 2, wherein in the step of detecting, a tilt an-gle is detected, by which the second surface is tilted in relation to a direction of inci-dence of the light beam and wherein in step of calculating, the refractive index is calculated in consideration of the tilt angle.

4. The method as claimed in claim 1, having a step of aligning the mirror surface of the mirror element approximately orthogonal to the light beam.

5. The method as claimed in claim 1, wherein in the step of detecting, the first reflection light beam, the second reflection light beam, and the third reflection light beam are detected simultaneously.

6. The method as claimed in claim 1, wherein the steps of detecting, determining, and calculating are performed repeatedly, wherein in the repeated step of detecting, the reflection light beams are inter-preted as reflections of different wavelengths.

7. The method as claimed in claim 1, wherein in the step of emitting, the light beam is emitted at an angle between 8° and 100°, in particu-lar at a right angle, with respect to the first surface of the test object.

8. A device, which is configured to carry out and/or actuate steps of the method as claimed in claim 1 in corresponding units.

9. A measuring system for measuring a refractive index of an optical test object, wherein the measuring system comprises the following features comprising:
a light source for emitting a light beam;
a receptacle element for receiving the optical test object;
a mirror element arranged on a side of the receptacle element opposite to the light source; and
a device, which is configured to carry out and/or actuate steps of the method as claimed in claim 1 in corresponding units, wherein the device is designed to actuate a light source and/or a receptacle element and/or a mirror element of the measuring system and wherein the device is designed to actuate a rotation of the test object around an axis of rotation arranged parallel to the light beam, wherein the rotation is performed simultaneously with the step of detecting.

10. The measuring system as claimed in claim 9, having an autocollimator comprising the light source, wherein the autocollimator comprises a plurality of exchangeable optical filters for filtering the light beam, in particular wherein the auto-collimator has at least one optical element, which is movable parallel to the optical axis of the autocollimator.

11. The measuring system as claimed in claim 9, wherein the mirror element comprises an adjustable aperture diaphragm, and/or wherein the mirror element is pivotable into the beam path of the light beam.

12. The measuring system as claimed in claim 9, wherein the receptacle element is rotatably mounted.

13. The measuring system as claimed in claim 9, wherein the light source and the mirror element are rotatable around a common axis.

14. The measuring system as claimed in claim 9, wherein the re-ceptacle element is designed to receive a liquid and/or a solid.

15. A computer program, which is configured to carry out and/or actuate the steps of the method as claimed in claim 1 when the computer pro-gram is executed on a computer or a device.
